(19) United States
(12) Patent Application Publication
(10) Pub. No.: US 2003/0070774 A1
(43) Pub. Date: Apr. 17, 2003

(54) Extendable window coverings for a vehicle

(76) Inventor: Hongbiao Li, Plano, TX (US)

Correspondence Address: Michael L. Diaz, Michael L. Diaz, P.C., 555 Republic Drive, Suite 200, Plano, TX, 75074, US

(21) Appl. No.: 10/273,008

(22) Filed: Oct. 17, 2002

Related U.S. Application Data
(63) Continuation-in-part of application No. 09/974,577, filed on Oct. 11, 2001.

(51) Int. Cl. B60J 3/00

(52) U.S. Cl. 160/370.21

(57) ABSTRACT

A window covering system for covering a plurality of windows of a vehicle. The window covering system includes a plurality of window coverings sized and shaped to cover each window of the vehicle. Each window covering includes a bottom portion having a substantially rigid perimeter which biases the window covering to a fully extended position. At least one wire is attached to each window covering at its bottom portion. The wires are retracted and extended by a wire retracted apparatus affixed to a top surface of the roof of the vehicle.

### RELATED APPLICATIONS

This application is a continuation-in-part of a co-pending U.S. patent application (Ser. No. 09/974,577, Attorney Docket No. 5011-0004) entitled “Retractable Window Shades for an Automobile,” filed Oct. 11, 2001 in the name of Hongbiao Li, which is hereby incorporated in its entirety by reference herein.

### BACKGROUND OF THE INVENTION

1. Technical Field of the Invention

This invention relates to window shades and, more particularly, to a plurality of retractable window shades for use on a vehicle.

2. Description of Related Art

As discussed in patent application Ser. No. 09/974,577 ('577), in hot climates, it is quite common for vehicles' interiors to become uncomfortably hot. '577 disclosed a plurality of window shades which allowed a driver to cover the windows when the vehicle is not in use. Although '577 provides a system of shades to cover the window, the system requires the use of complex and possibly expensive components to make the shades useable. A system and apparatus are needed which covers the windows, yet is simple in construction and inexpensive. Thus, it would be a distinct advantage to have an apparatus which shades all the windows of the vehicle, is easily deployed and inexpensive. It is an object of the present invention to provide such an apparatus and system.

### SUMMARY OF THE INVENTION

In one aspect, the present invention is a window covering system for use on a vehicle. The window covering system includes a window covering sized and shaped to cover a window of the vehicle. The window covering having a bottom portion which biases the window covering to a fully extended configuration. The system also includes a wire attached to a bottom portion of the window covering and a wire retracting apparatus for retracting and extending the wire. The wire retracting apparatus is attached to a top portion of the vehicle. The window covering covers the window covering when the wire is extended. The window covering is retracted by the wire when retracting the window covering.

In another aspect, the present invention is a window covering system for use on a vehicle. The window covering system includes a plurality of window coverings. Each window covering is sized and shaped to cover a window of the vehicle. In addition, each window covering has a bottom portion which biases the window covering to a fully extending configuration. The system also includes a plurality of wires, each wire attached to a bottom portion of one of the window coverings. Additionally, a wire retracting apparatus for retracting and extending the plurality of wires is included in the system. The wire retracting apparatus is attached to a top portion of the vehicle. The plurality of window coverings cover the window covering when the wire is extended. The plurality of window coverings are retracted by the plurality of wires when retracting the window covering.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a top plan view of a vehicle having a plurality of window coverings in a retracted position;

FIG. 2 is a top plan view of a vehicle having a plurality of window coverings in the extended position;

FIG. 3 is a top view of the vehicle illustrating a plurality of window coverings in a retracted position in an alternate embodiment of the present invention;

FIG. 4 is a top view of the vehicle illustrating the window coverings of FIG. 3 in the extended position;

FIG. 5 is a top view of the window coverings utilizing eight wires;

FIG. 6 is a top view of the window coverings in a retracted position on a vehicle having a sunroof in a second alternate embodiment; and

FIG. 7 is a top view of the window coverings of FIG. 6 in an extended position.

### DETAILED DESCRIPTION OF EMBODIMENTS

The present invention is an extendable window covering system for use on a vehicle. FIG. 1 is a top plan view of a vehicle 70 having a plurality of window coverings 10D in a retracted position. The vehicle includes a plurality of windows 14. Each window includes a corresponding window covering 10D. A plurality of wires are attached to a bottom portion 43 of each window covering. Each wire may be retracted and extended by a wire retracting apparatus 39.

In the preferred embodiment of the present invention, the wire retracting apparatus 39 is affixed to a top surface of a roof of the vehicle 70. The wire retracting apparatus has the plurality of wires originating from it and extending outwardly to the bottom portion 43 of each window covering 10D. The wire retracting apparatus may be any device which enables each wire to be extended or retracted as desired. For example, the wire retracting apparatus may include a rotatable post which wraps the wire around the post during retraction. In another embodiment, the wire retracting apparatus may be a motor which retracts and extends the wires.

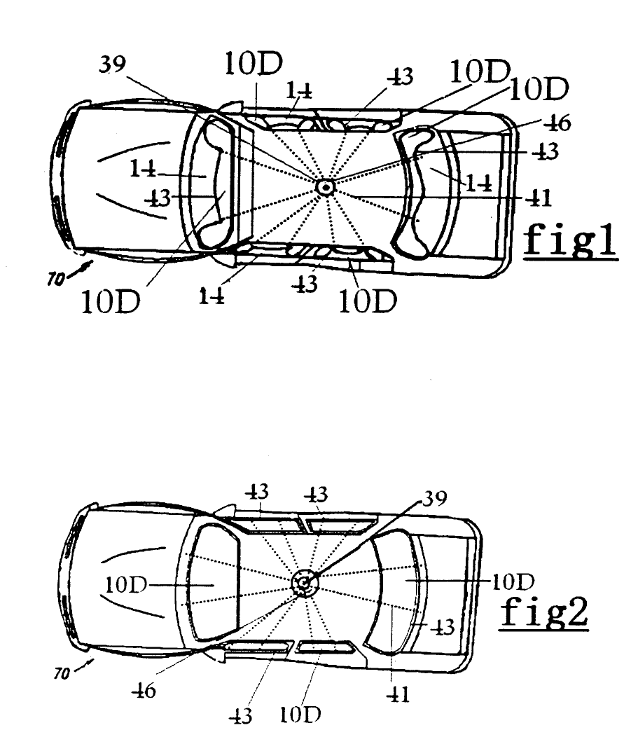

Each window covering may be constructed of any material which prevents the sun from completely shining through the windows 14. Additionally, in the preferred embodiment of the present invention, the window coverings are biased to an extended position (see FIG. 2) in which the covering covers the entire window.

FIG. 2 is a top plan view of a vehicle 70 having a plurality of window coverings 10D in an extended position. When the plurality of wires 41 are extended to their full position, the window coverings 10D are extended outwardly to completely cover each window.

With reference to FIGS. 1 and 2, the operation of the window coverings 10D will now be explained. When driving the vehicle, or when it is desired to allow visibility through the windows 14, the window coverings are positioned in its “open” or retracted position. The wires 41 are retracted inwardly toward the wire retracting apparatus 39. Thus, the wires exposed length is shorted in the retracted position. Retracting the wires allows the wires to pull upwardly the bottom portion 43 of each window covering 10D, thus enabling visibility through each window.

When it is desired to cover the windows 14, the wire retracting apparatus extends (lengthens the exposed wire), thus enabling the extendable biased window covering to extend downwardly. In the fully extended position, the window covering completely covers the window. The window covering may be biased downwardly by constructing the window covering material from a substance having a flexible yet substantially rigid perimeter to bias the covering outwardly.

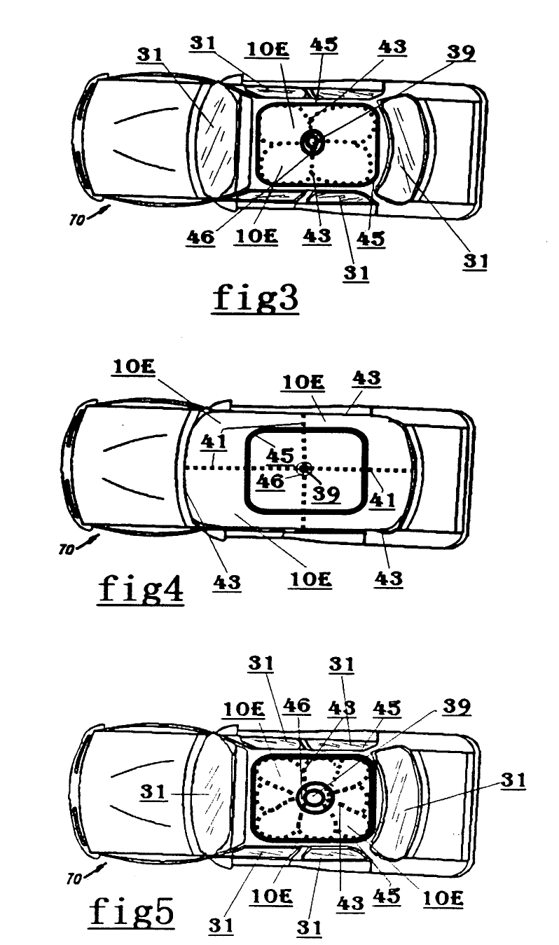

FIG. 3 is a top view of the vehicle 70 illustrating a plurality of window coverings 10E in a retracted position in an alternate embodiment of the present invention. The window coverings 10E may be contained within a storage area 45 located on a top surface of the roof of the vehicle. The window coverings 10E include a plurality of wires 41 (FIG. 4) attached to a bottom portion 43 of each covering 10E. In an alternate embodiment of the present invention, the storage area 45, window coverings, and wire retracting apparatus 39 may be located within an interior of the vehicle, such as on the bottom surface of the roof of the vehicle.

In the retracted position, the coverings 10E are all contained within the storage area 45. The storage area is a stationary covering for which the window coverings may be stored. In addition, under the storage area may be located the wire retracting apparatus 39.

FIG. 4 is a top view of the vehicle 70 illustrating the window coverings 10E of FIG. 3 in the extended position. The window coverings are extended to cover each window of the vehicle. The window coverings 10E include the bottom portion 43 which may include a material which is biased to an outwardly extended position, enabling the window covering to cover the entire window. The bottom portion may be constructed of a substantially rigid material having some flexing qualities, such as a plastic. In the extended position, the wires 41 are extended outward, thus enabling the window coverings to cover the windows. The storage area also remains in its same position.

In operation, the window coverings 10E are retracted and extended by shortening and lengthening the wires as desired. As discussed above, the wire retracting apparatus may be any device which may extend or retract the wires. As depicted in FIGS. 3 and 4, there are four wires. Each wire is attached to a mid-section of the bottom portion 43 of the window covering. However, any number of wires may be utilized. FIG. 5 is a top view of the window coverings 10E utilizing eight wires 41. It should be understood, that any number of wires may be used to enable the window coverings to be retracted and extended as desired.

In an alternate embodiment of the present invention, the plurality of window coverings, wire, and wire retracting apparatus may be located within an interior portion of the vehicle. The wire retracting apparatus may be affixed to a bottom surface of the vehicle's roof. The vehicle may be any type of transportation system, such as a truck, boat, or train.

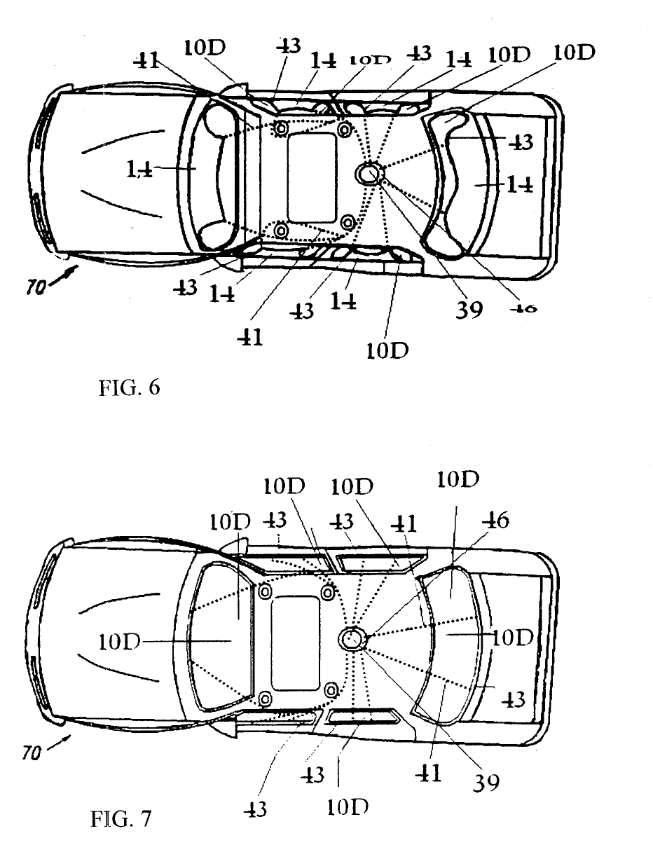

FIG. 6 is a top view of the window coverings 10D in a retracted position on a vehicle 70 having a sunroof in a second alternate embodiment. FIG. 7 is a top view of the window coverings of FIG. 6 in an extended position. The window coverings may be configured to avoid covering specific areas of the vehicle. As depicted, the wires may be affixed to the bottom portion of each window shade in such a manner as to avoid covering the sunroof.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A window covering system for use on a vehicle, the window covering system comprising:
a window covering sized and shaped to cover a window of the vehicle, the window covering having a bottom portion which biases the window covering to a fully extended configuration;
a wire attached to a bottom portion of the window covering;
a wire retracting apparatus for retracting and extending the wire, the wire retracting apparatus attached to a top portion of the vehicle;
whereby the window covering covers the window covering when the wire is extended, the window covering being retracted by the wire when retracting the window covering.

2. The window covering system of claim 1 wherein the wire retracting apparatus is affixed to a top surface of a roof of the vehicle.

3. The window covering system of claim 1 wherein the wire retracting apparatus is affixed within an interior of the vehicle.

4. The window covering system of claim 1 wherein the wire retracting apparatus is a motor for retracting and extending the wire.

5. The window covering system of claim 1 wherein the wire retracting apparatus is a rotating post affixed to a top surface of the vehicle, the rotating post wrapping the wire around the post to retract the wire.

6. The window covering system of claim 1 wherein the window covering system includes a plurality of window coverings and a plurality of wires, each wire attached to a bottom portion of one of the plurality of window coverings;
whereby the wire retracting apparatus retracts the plurality of wires to retract the plurality of window coverings from a plurality of windows located on the vehicle.

7. The window covering system of claim 7 further comprising a storage area affixed to a top surface of a roof of the vehicle, the storage area storing the plurality of window coverings in the retracted position.

8. The window covering system of claim 1 wherein the bottom portion having a substantially rigid perimeter.

9. A window covering system for use on a vehicle, the window covering system comprising:
a plurality of window coverings, each window covering sized and shaped to cover a window of the vehicle, each window covering having a bottom portion which biases the window covering to a fully extending configuration;
a plurality of wires, each wire attached to a bottom portion of one of the window coverings;
a wire retracting apparatus for retracting and extending the plurality of wires, the wire retracting apparatus attached to a top portion of the vehicle;
whereby the plurality of window coverings cover the window covering when the wire is extended, the plurality of window coverings being retracted by the plurality of wires when retracting the window covering.
